(19) United States
(12) Patent Application Publication
(10) Pub. No.: US 2026/0075352 A1
(43) Pub. Date: Mar. 12, 2026

(54) TRANSDUCER ASSEMBLY, HEADPHONE, AND HEADPHONE SYSTEM

(71) Applicant: SUUNTO SPORTS TECHNOLOGY (DONGGUAN) CO., LTD., Dongguan (CN)

(72) Inventors: Junlin CHEN, Dongguan (CN); Zhonglin ZHANG, Dongguan (CN)

(21) Appl. No.: 19/394,923

(22) Filed: Nov. 20, 2025

Related U.S. Application Data
(63) Continuation of application No. PCT/CN2025/117794, filed on Aug. 29, 2025.

(30) Foreign Application Priority Data
Aug. 30, 2024 (CN) 202422134695.4

(51) Int. Cl. H04R 1/10; H04R 1/06; H04R 9/02; H04R 9/04; H04R 9/06

(52) U.S. Cl. CPC H04R 1/1075; H04R 1/06; H04R 9/025; H04R 9/045; H04R 9/06; H04R 1/1025; H04R 1/105; H04R 2460/13

(57) ABSTRACT

A transducer assembly includes a first housing, a second housing, and a support. The first housing and the second housing are connected to each other and jointly define an accommodation cavity. The support is located in the accommodation cavity and connected to the second housing. The support and the first housing jointly define a mounting cavity. The support has a through hole. An adhesive receiving portion is provided in the mounting cavity. The through hole corresponds to and is in communication with the adhesive receiving portion.

### CROSS-REFERENCE TO RELATED APPLICATION

This application is a continuation of International Application No. PCT/CN2025/117794, filed on Aug. 29, 2025, which claims priority to and benefits of Chinese patent application No. 202422134695.4, filed with China National Intellectual Property Administration on Aug. 30, 2024, the entire content of which incorporated herein by reference.

### FIELD

The present disclosure relates to the field of headphone technologies, and more particularly, to a transducer assembly, a headphone, and a headphone system.

### BACKGROUND

A bone conduction headphone is a type of headphone that uses human bones as a medium to transmit sound directly to the auditory organs without passing through the external acoustic meatus and tympanic membrane. The bone conduction headphone can convert sound into mechanical vibrations. When the headphone is operating, a transducer assembly that is in close contact with human skin vibrates. The vibration from the transducer assembly can be transmitted to the human auditory nerve through the human skin, subcutaneous tissue, and the bones, allowing a person to hear the sound. The bone conduction headphone achieves sound conduction without the vibration of the tympanic membrane, which not only improves comfort and protects the user's hearing, but also allows the user to still hear external sounds, endowing it with unique advantages. A housing of the transducer assembly and a support in the housing are usually connected by adhesive.

### SUMMARY

A transducer assembly, a headphone, and a headphone system are provided in embodiments of the present disclosure.

The transducer assembly according to the embodiments of the present disclosure includes a first housing, a second housing, and a support. The second housing is connected to the first housing, and the first housing and the second housing jointly define an accommodation cavity. The support is located in the accommodation cavity and connected to the second housing. The support and the first housing jointly define a mounting cavity. The support has a through hole. An adhesive receiving portion is provided in the mounting cavity. The through hole corresponds to the adhesive receiving portion.

In some embodiments, the adhesive receiving portion has an adhesive receiving space in communication with the through hole.

In some embodiments, the adhesive receiving portion and an inner wall of the first housing are connected to each other and jointly define the adhesive receiving space. The first housing has a passage hole in communication with the adhesive receiving space. The passage hole is configured to allow an electrical connector to pass through the adhesive receiving space to enter the accommodation cavity.

In some embodiments, at least a portion of the adhesive receiving portion is spaced apart from the inner wall of the first housing to form a first opening and a second opening. The adhesive receiving space is in communication with the through hole via the first opening and in communication with the passage hole via the second opening.

In some embodiments, the transducer assembly further includes a vibration component located in the mounting cavity and connected to the support. The vibration component is capable of vibrating when energized.

In some embodiments, the vibration component includes a coil, a magnetic member, and an elastic sheet. The coil is fixedly connected to the support and surrounds the magnetic member. The coil is further electrically connected to an electrical connector. The elastic sheet is connected to each of the support and the magnetic member. A magnetic field generated by the coil when energized is coupled with a magnetic field of the magnetic member to drive the magnetic member to move. The magnetic member is capable of driving the elastic sheet to vibrate with a change of an energization direction of the coil.

In some embodiments, the transducer assembly further includes a protective member connected to the magnetic member and surrounding the magnetic member and the coil.

In some embodiments, the vibration component further includes a connection member. The magnetic member has a first passage hole. The elastic sheet has a second passage hole. The protective member has a third passage hole. The first passage hole, the second passage hole, and the third passage hole correspond to one another. The magnetic member is connected to each of the elastic sheet and the protective member by the connection member passing through the first passage hole, the second passage hole, and the third passage hole.

In some embodiments, the vibration component further includes a first magnetic conductive member and a second magnetic conductive member. The first magnetic conductive member and the second magnetic conductive member are disposed between the magnetic member and the elastic sheet and configured to transmit a magnetic field of the coil to the magnetic member.

In some embodiments, the elastic sheet, the first magnetic conductive member, the second magnetic conductive member, the magnetic member, and the protective member are fixedly connected by the connection member sequentially passing through the elastic sheet, the first magnetic conductive member, the second magnetic conductive member, the magnetic member, and the protective member.

The headphone according to the embodiments of the present disclosure includes the transducer assembly according to the above-described embodiments.

In some embodiments, the headphone includes a bone conduction headphone and an air conduction headphone.

The headphone system according to the embodiments of the present disclosure includes the headphone according to the above-described embodiments and a charging case configured to charge the headphone.

Additional aspects and advantages of the present disclosure will be provided in part in the following description, or will become apparent in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a schematic perspective view of a headphone according to some embodiments of the present disclosure.

FIG. 2 is a schematic perspective view of a transducer assembly in the headphone of FIG. 1.

FIG. 3 is a schematic partial structural view of the transducer assembly in FIG. 2.

FIG. 4 is a schematic cross-sectional view of the transducer assembly in FIG. 2 taken along line IV-IV.

FIG. 5 is a schematic perspective exploded view of the transducer assembly in FIG. 2.

FIG. 6 is a schematic perspective view of a headphone system according to some embodiments of the present disclosure.

### DETAILED DESCRIPTION OF THE EMBODIMENTS

To make the above-mentioned objects, features, and advantages of the present disclosure more obvious and comprehensive, a detailed description of specific embodiments of the present disclosure will be given below in conjunction with the accompanying drawings. In the following description, many specific details are provided to facilitate full understanding of the present disclosure. However, the present disclosure can be implemented in many other ways than those described herein, and similar improvements can be made by those skilled in the art without contradicting the intent of the present disclosure. Therefore, the present disclosure is not limited by specific embodiments disclosed below.

In the description of the present disclosure, it should be understood that the orientation or the position indicated by terms such as “center”, “longitudinal”, “transverse”, “length”, “width”, “thickness”, “over”, “below”, “front”, “rear”, “left”, “right”, “vertical”, “horizontal”, “top”, “bottom”, “inner”, “outer”, “clockwise”, “anti-clockwise”, “axial”, “radial”, and “circumferential” should be construed to refer to the orientation or the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure.

In addition, terms “first” and “second” are only used for descriptive purposes, and cannot be understood as indicating or implying relative importance or implicitly indicating the number of indicated technical features. Therefore, the features defined with “first” and “second” may explicitly or implicitly include at least one of the features. In the description of the present disclosure, “plurality” means at least two, such as two and three, unless otherwise specifically defined.

In the present disclosure, unless otherwise clearly specified and limited, terms such as “install”, “connect”, “connect to”, “fix”, and the like should be understood in a broad sense. For example, it may be a fixed connection or a detachable connection or connection as one piece; mechanical connection or electrical connection; direct connection or indirect connection through an intermediate; internal communication of two components or the interaction relationship between two components, unless otherwise specifically defined. For those of ordinary skill in the art, the specific meaning of the above-mentioned terms in the present disclosure can be understood according to specific circumstances.

In the present disclosure, unless specified or limited otherwise, the first characteristic “on” or “under” the second characteristic may mean that the first characteristic and the second characteristic are in direct contact with each other or in indirect contact via media. And, the first characteristic “on”, “above”, “over” the second characteristic may mean that the first characteristic is right over the second characteristic or is diagonal above the second characteristic, or just mean that the horizontal height of the first characteristic is higher than the horizontal height of the second characteristic. The first characteristic “below” or “under” the second characteristic may mean that the first characteristic is right over the second characteristic or is diagonal under the second characteristic, or just mean that the horizontal height of the first characteristic is lower than the horizontal height of the second characteristic.

It should be noted that when an element is described as being “fixed to” or “arranged on” another element, it may be directly on the other element or an intermediate element may exit. When an element is interpreted as being “connected” to another element, it may be directly connected to the other element or an intermediate element may exit simultaneously. As used herein, the terms “vertical”, “horizontal”, “over”, “below”, “left”, and “right” and similar expressions are used for illustrative purposes only and are not meant to be the only means of implementation.

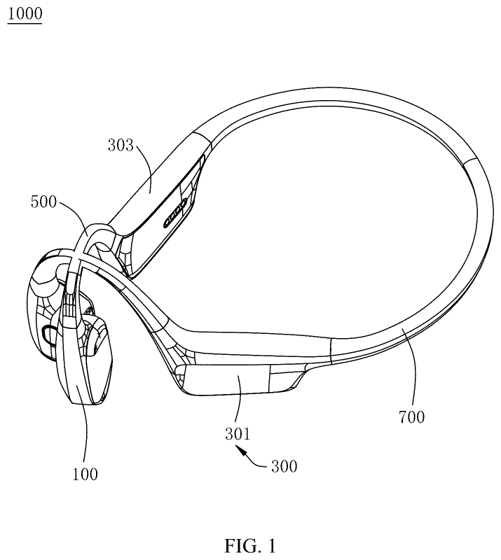

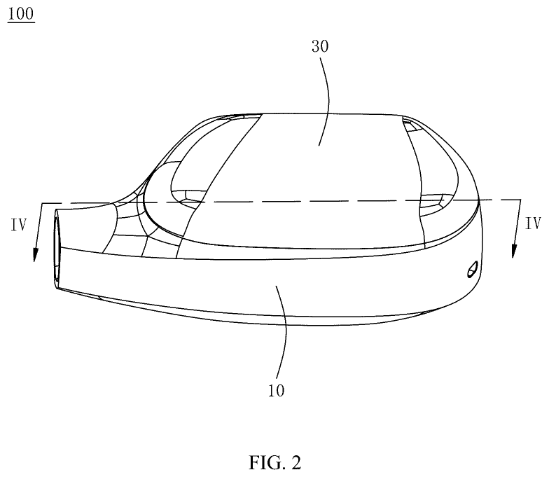

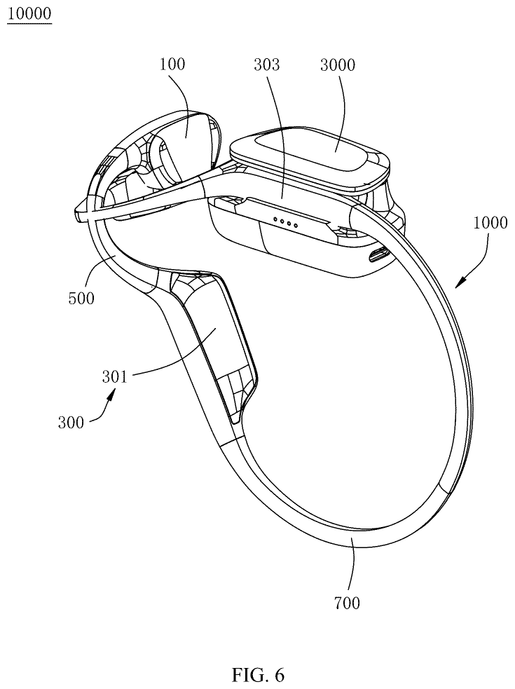

A bone conduction headphone is a type of headphone that uses human bones as a medium to transmit sound directly to auditory organs without passing through the external acoustic meatus and tympanic membrane. The bone conduction headphone can convert sound into mechanical vibrations. When the headphone is operating, a transducer assembly that is in close contact with human skin vibrates. The vibration from the transducer assembly can be transmitted to the human auditory nerve through the human skin, subcutaneous tissue, and the bones, allowing a person to hear the sound. The bone conduction headphone achieves sound conduction without the vibration of the tympanic membrane, which not only improves comfort and protects user's hearing, but also allows the user to still hear external sounds, endowing it with unique advantages. A housing of the transducer assembly and a support in the housing are usually connected by adhesive. However, when there is an excessive amount of adhesive between the housing and the support, a problem of adhesive overflow occurs during connection of the housing and the support. The adhesive that overflows onto a surface of the transducer assembly affects the overall appearance of the headphone and is difficult to clean. To solve this problem, a transducer assembly 100 (as illustrated in FIG. 2), a headphone 1000 (as illustrated in FIG. 1), and a headphone system 10000 (as illustrated in FIG. 6) are provided according to embodiments of the present disclosure.

As illustrated in FIG. 1 and FIG. 2, the headphone 1000 according to the embodiments of the present disclosure includes the transducer assembly 100. In some embodiments, the headphone 1000 includes a bone conduction headphone 1000 and an air conduction headphone 1000.

The bone conduction headphone 1000 uses human bones as a medium and converts sound into mechanical vibrations. The mechanical vibrations transmit sound waves through the human bones, to allow the user to hear the sound. Since the sound of the bone conduction headphone 1000 acts on the bones, long-term use does not cause a significant impact on the tympanic membrane of the user's ears, which can effectively protect the user's hearing. The air conduction headphone 1000 transmits sound through air vibration, and has better sound quality and penetration. The headphone 1000 of the present disclosure is described by taking the bone conduction headphone 1000 as an example. In addition, the bone conduction headphone 1000 of the present disclosure may be a swimming headphone 1000. The user can wear the bone conduction headphone 1000 while swimming and diving, and the bone conduction headphone 1000 has better waterproof performance.

As illustrated in FIG. 1 and FIG. 2, the transducer assembly 100 of the present disclosure is configured to be in close contact with the human skin. When the headphone 1000 is in use, the transducer assembly 100 can generate vibrations that are transmitted through the human bones, allowing the user to hear the sound. The headphone 1000 of the present disclosure further includes a function box assembly 300 electrically connected to the transducer assembly 100. The function box assembly 300 may include a battery box assembly 303 and/or a control box assembly 301. The control box assembly 301 may be configured to control power-on and power-off of the headphone 1000 and adjust volume of the headphone 1000. The battery box assembly 303 includes a battery configured to supply power to other components of the headphone 1000, to guarantee normal operation of the headphone 1000.

In some embodiments, the headphone 1000 further includes an ear hook 500 and a rear hook 700. The ear hook 500 is configured to be electrically connected to the battery box assembly 303 and the transducer assembly 100 and to be electrically connected to the control box assembly 301 and the transducer assembly 100. The rear hook 700 is configured to be electrically connected to the battery box assembly 303 and the control box assembly 301. When the user wears the headphone 1000, the rear hook 700 of the headphone 1000 is worn on the head, and the ear hook 500 of the headphone 1000 is worn on a back of the ear, which can improve wearing stability of the headphone 1000, ensuring that the headphone 1000 is less likely to fall off when the user is outdoors or exercising.

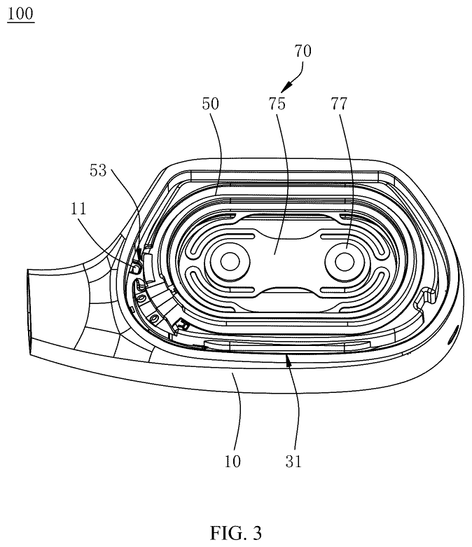

As illustrated in FIG. 3 to FIG. 5, the transducer assembly 100 according to the embodiments of the present disclosure includes a first housing 10, a second housing 30, and a support 50. The second housing 30 is connected to the first housing 10, and the first housing 10 and the second housing 30 jointly define an accommodation cavity 31. A support 50 is located in the accommodation cavity 31 and connected to the second housing 30. The support 50 and the first housing 10 jointly define a mounting cavity 51. The support 50 has a through hole 53. An adhesive receiving portion 11 is provided in the mounting cavity 51. The through hole 53 corresponds to and is in communication with the adhesive receiving portion 11.

In an exemplary embodiment of the present disclosure, the first housing 10 may be connected to the second housing 30 through a snap connection, interference fit, bonding, etc. Exemplarily, the first housing 10 may be connected to the second housing 30 by means of bonding. Preferably, the first housing 10 and the second housing 30 can be bonded and connected through waterproof adhesive. In this case, connection between the first housing 10 and the second housing 30 is relatively stable, making the first housing 10 less likely to detach from the second housing 30. Furthermore, the waterproof performance between the first housing 10 and the second housing 30 is better, preventing external liquid from entering the accommodation cavity 31 through a clearance between the first housing 10 and the second housing 30. The support 50 and other components of the transducer assembly 100 are mounted in the accommodation cavity 31, and the external liquid is not easy to enter the accommodation cavity 31, in such a manner that the components in the accommodation cavity 31 are less likely to be damaged.

As illustrated in FIG. 3 to FIG. 5, the support 50 has a side fixedly connected to the second housing 30 and another side configured for mounting of a vibration component 70 of the transducer assembly 100, in such a manner that the vibration component 70 of the transducer assembly 100 can be fixedly connected to the second housing 30 through the support 50. The support 50 and the second housing 30 of the present disclosure can be connected by means of bonding, which makes the connection between the support 50 and the second housing 30 relatively stable and can effectively prevent the external liquid from entering the accommodation cavity 31 through the clearance between the support 50 and the second housing 30. When the support 50 is connected to the second housing 30, the waterproof adhesive can be first applied to a side of the support 50 facing away from the mounting cavity 51, and then the second housing 30 is pressed tightly against the support 50. The waterproof adhesive between the support 50 and the second housing 30 flows into the adhesive receiving portion 11 through the through hole 53, which can effectively prevent the waterproof adhesive from flowing out to a surface of the transducer assembly 100 through the clearance between the support 50 and the second housing 30. Therefore, the transducer assembly 100 has better overall aesthetics and there is no need to clean the waterproof adhesive on the surface of the transducer assembly 100, making mounting of the transducer assembly 100 relatively simple.

The number of through holes 53 may be one, two, three, four, or more. When one through hole 53 is provided, the through hole 53 can be disposed at any position on the support 50. In this case, a structure of the support 50 is simpler, and processing is more convenient. When a plurality of through holes 53 are provided, the plurality of through holes 53 can be evenly or unevenly distributed on the support 50. In this case, a plurality of adhesive receiving portions 11 may also be provided and correspond to the plurality of through holes 53, respectively. The waterproof adhesive on the support 50 can quickly enter the adhesive receiving portion 11 through the plurality of through holes 53, which can further prevent the waterproof adhesive between the support 50 and the second housing 30 from flowing out to the surface of the transducer component 100.

As illustrated in FIG. 3 to FIG. 5, the vibration component 70 and other components of the transducer assembly 100 are mounted in the mounting cavity 51. The adhesive receiving portion 11 is configured to accommodate the waterproof adhesive flowing out of the through hole 53, preventing the waterproof adhesive from flowing into other components in the mounting cavity 51 and affecting normal operation of these components. In some embodiments, the adhesive receiving portion 11 has an adhesive receiving space 111 in communication with the through hole 53. The adhesive receiving space 111 is configured to store the waterproof adhesive that flows in through the through hole 53. A side of the support 50 facing towards the mounting cavity 51 abuts against a top wall of the adhesive receiving portion 11. The through hole 53 corresponds to and is in communication with the adhesive receiving portion 11 in the thickness direction of the transducer assembly 100. When the support 50 is connected to the second housing 30, the support 50 and the second housing 30 jointly squeeze the waterproof adhesive, allowing the waterproof adhesive to flow directly into the adhesive receiving portion 11 through the through hole 53. In this way, the waterproof adhesive can be effectively prevented from flowing out through the clearance between the through hole 53 and the adhesive receiving portion 11.

In the transducer assembly 100 according to the embodiments of the present disclosure, the support 50 has the through hole 53, the adhesive receiving portion 11 is disposed in the mounting cavity 51, and the through hole 53 corresponds to and is in communication with the adhesive receiving portion 11. The support 50 and the second housing 30 can be bonded and connected by the waterproof adhesive. When the support 50 and the second housing 30 are connected and jointly squeeze the waterproof adhesive, the waterproof adhesive can flow into the adhesive receiving portion 11 through the through hole 53, and the waterproof adhesive can be stored in the adhesive receiving portion 11. In this way, the problem of the waterproof adhesive between the support 50 and the second housing 30 overflowing onto the surface of the transducer assembly 100 can be avoided. Therefore, the transducer assembly 100 has better overall aesthetics, and there is no need to clean the waterproof adhesive on the surface of the transducer assembly 100, making the mounting of the transducer assembly 100 relatively simple.

The transducer assembly 100 is further described below with reference to the accompanying drawings.

As illustrated in FIG. 3 to FIG. 5, in some embodiments, the adhesive receiving portion 11 and an inner wall of the first housing 10 are connected to each other and jointly define the adhesive receiving space 111. The first housing 10 has a passage hole 13 in communication with the adhesive receiving space 111. The passage hole 13 is configured to allow an electrical connector 90 to pass through the adhesive receiving space 111 to enter the accommodation cavity 31.

The adhesive receiving portion 11 and the first housing 10 may be integrally formed as one piece or formed as separate pieces. When the adhesive receiving portion 11 and the first housing 10 are integrally formed as one piece, the adhesive receiving portion 11 and the first housing 10 can be integrally formed, making processing steps of the transducer assembly 100 relatively simple and connection between the adhesive receiving portion 11 and the first housing 10 relatively stable. When the adhesive receiving portion 11 and the first housing 10 are formed as separate pieces, the adhesive receiving portion 11 and the first housing 10 are connected either detachably or non-detachably. The detachable mounting method includes, but is not limited to, a threaded connection, a screw connection, a snap-fit connection, etc. The non-detachable mounting method includes, but is not limited to, welding, adhesive bonding, interference fit, etc.

The passage hole 13 is configured to allow an end of the ear hook 500 to extend into the passage hole 13. The electrical connector 90 is disposed in the ear hook 500. When the ear hook 500 extends into the passage hole 13 to be connected to the transducer assembly 100, the electrical connector 90 can extend into the accommodation cavity 31 to be electrically connected to the components in the accommodation cavity 31. Because the waterproof adhesive is stored in the adhesive receiving space 111, when the electrical connector 90 passes through the adhesive receiving space 111 and enters the accommodation cavity 31, a part of the electrical connector 90 in the adhesive receiving space 111 is fixed by the waterproof adhesive, which can prevent the electrical connector 90 in the accommodation cavity 31 from shaking or vibrating and generating noise.

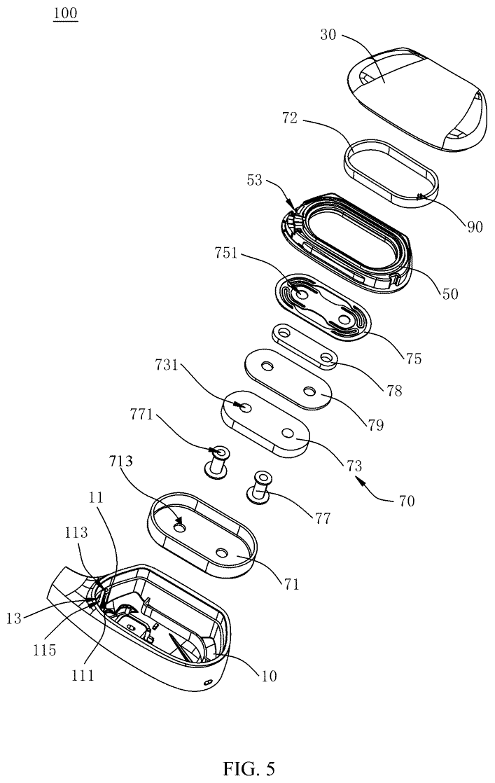

As illustrated in FIG. 5, in some embodiments, at least a portion of the adhesive receiving portion 11 is spaced from the inner wall of the first housing 10 to form a first opening 113 and a second opening 115. The adhesive receiving space 111 is in communication with the through hole 53 via the first opening 113 and in communication with the passage hole 13 via the second opening 115.

The first opening 113 corresponds to and is in communication with the through hole 53. During a process of connecting the support 50 to the second housing 30, the through hole 53 is configured to allow the waterproof adhesive to flow to the first opening 113 and then into the glue receiving space 111 through the first opening 113. In the present disclosure, the adhesive receiving portion 11 is offset from the passage hole 13 in the length direction of the transducer assembly 100, which can prevent the adhesive receiving portion 11 from blocking the electrical connector 90 from extending into the accommodation cavity 31. The second opening 115 is disposed at a side of the adhesive receiving portion 11 close to the passage hole 13. The electrical connector 90 can enter the adhesive receiving space 111 through the second opening 115 and then extend into the accommodating cavity 31 through the first opening 113, in such a manner that the electrical connector 90 can be electrically connected to the components in the accommodation cavity 31.

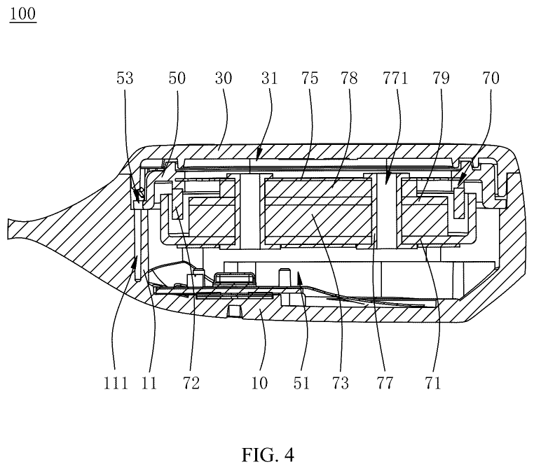

As illustrated in FIG. 4 and FIG. 5, further, in some embodiments, the transducer assembly 100 further includes a vibration component 70 located in the mounting cavity 51 and connected to the support 50. The vibration component 70 is capable of vibrating when energized.

The electrical connector 90 extends into the accommodation cavity 31 and is electrically connected to the vibration component 70. When the headphone 1000 is in use, the electrical connector 90 can supply power to the vibration component 70, causing the vibration component 70 to vibrate. At least a portion of the vibration component 70 is connected to the support 50. When the vibration component 70 vibrates, it drives the support 50 to vibrate, in such a manner that the support 50 can drive the first housing 10 and the second housing 30 to vibrate together. When the user wears the headphone 1000, the second housing 30 can be in close contact with the human skin, and the vibration from the second housing 30 can be transmitted through the human bones, allowing the user to hear the sound. When the support 50 has the through hole 53 and the mounting cavity 51 is provided with the adhesive receiving portion 11, a problem that normal operation (vibration) of the vibration component 70 is affected by the waterproof adhesive on the support 50 flowing into the vibration component 70 can be effectively avoided.

As illustrated in FIG. 4 and FIG. 5, in some embodiments, the vibration component 70 includes a coil 72, a magnetic member 73, and an elastic sheet 75. The coil 72 is fixedly connected to the support 50 and surrounds the magnetic member 73. The coil 72 is further electrically connected to the electrical connector 90. The elastic sheet 75 is connected to each of the support 50 and the magnetic member 73. A magnetic field generated by the coil 72 when energized is coupled with a magnetic field of the magnetic member 73 to drive the magnetic member 73 to move. The magnetic member 73 is capable of driving the elastic sheet 75 to vibrate with a change of an energization direction of the coil 72.

In an exemplary embodiment of the present disclosure, the coil 72 can be fixedly connected to the side of the support 50 facing towards the mounting cavity 51 by means of bonding. In this case, the structure of the support 50 is relatively simple, and there is no need to design a connection structure on the support 50. Furthermore, the connection between the coil 72 and the support 50 is relatively stable, making the coil 72 less likely to become loose relative to the support 50 when both the vibration component 70 and the support 50 vibrate. When the coil 72 surrounds the magnetic member 73, a coupling effect between the magnetic field of the coil 72 and the magnetic field of the magnetic member 73 is better, in such a manner that the coil 72 can effectively drive the magnetic member 73 to move.

Exemplarily, when a current in a first direction is applied to the coil 72, coupling between the magnetic field of the coil 72 and the magnetic field of the magnetic member 73 can allow the magnetic member 73 to move towards the second housing 30. When a current in a second direction is applied to the coil 72, the coupling between the magnetic field of the coil 72 and the magnetic field of the magnetic member 73 can allow the magnetic member 73 to move towards the first housing 10. The first direction is opposite to the second direction. When a direction of the current supplied by the electrical connector 90 to the coil 72 alternates continuously between the first direction and the second direction, the magnetic member 73 can move repeatedly and vibrate. When the magnetic member 73 is connected to the elastic sheet 75, the elastic sheet 75 can vibrate along with the magnetic member 73. When the elastic sheet 75 vibrates, it can drive the support 50 to vibrate, in such a manner that the support 50 can drive the first housing 10 and the second housing 30 to vibrate together. The vibration from the first housing 10 can be transmitted through the human bones, allowing the user to hear the sound.

The elastic sheet 75 may be integrally formed. For example, the elastic sheet 75 can be formed by blanking a metal sheet. The elastic sheet 75 can be formed by blanking a stainless steel sheet as desired. The elastic sheet 75 of the present disclosure is generally constructed as a thin, flat plate. The magnetic member 73 may be a permanent magnet. The permanent magnet may be a ferrite magnet, a neodymium iron boron magnet, etc. The magnetic member 73 of the present disclosure is generally a flat plate in shape.

As illustrated in FIG. 4 and FIG. 5, in some embodiments, the transducer assembly 100 further includes a protective member 71. The protective member 71 is located in the mounting cavity 51 and connected to the magnetic member 73. The protective member 71 surrounds the magnetic member 73 and the coil 72. The protective member 71 can be made of a magnetic isolation material. When the magnetic field of the coil 72 is coupled with the magnetic field of the magnetic member 73, the protective member 71 can be configured to prevent the magnetic field of the coil 72 and the magnetic field of the magnetic member 73 from leaking, to prevent the magnetic field from interfering with the operation of other components in the mounting cavity 51.

As illustrated in FIG. 4 and FIG. 5, in some embodiments, the vibration component 70 further includes a connection member 77. The magnetic member 73 has a first passage hole 731, the elastic sheet 75 has a second passage hole 751, and the protective member 71 has a third passage hole 713. The first passage hole 731, the second passage hole 751, and the third passage hole 713 correspond to one another. The magnetic member 73 is connected to each of the elastic sheet 75 and the protective member 71 by the connection member 77 passing through the first passage hole 731, the second passage hole 751, and the third passage hole 713.

The connection member 77 is configured to fixedly connect the magnetic member 73, the elastic sheet 75, and the protective member 71 together. When the magnetic member 73 vibrates, such configuration can facilitate the magnetic member 73 to drive the elastic sheet 75 to vibrate together. In addition, the magnetic member 73 can also drive the protective member 71 to vibrate together, in such a manner that relative fixation can be maintained between the magnetic member 73 and the protective member 71, and the protective member 71 can effectively prevent the magnetic field of the magnetic member 73 from leaking. The connection member 77 may be made of non-magnetic material. For example, the connection member 77 is made of stainless steel or aluminum alloy.

As illustrated in FIG. 4 and FIG. 5, in some embodiments, the connection member 77 has a fourth passage hole 771 through which a space between the second housing 30 and the support 50 is in communication with a space between the vibration component 70 and the first housing 10, to keep air pressure at two ends of the magnetic member 73 consistent.

When the transducer assembly 100 is in use, the vibration assembly vibrates back and forth in the accommodation cavity 31. During the back-and-forth vibration of the vibration component 70, the fourth passage hole 771 can keep air pressure values at the two sides of the magnetic member 73 (vibration component 70) consistent, to avoid a problem of poor vibration of the vibration component 70 caused by air pressure differences between the two sides of the magnetic member 73. By disposing the fourth passage hole 771 in the connection member 77, balanced vibration of the vibration component 70 can be guaranteed, to improve response accuracy of the transducer assembly of the bone conduction headphone 1000 and enhance service performance of the bone conduction headphone 1000.

As illustrated in FIG. 4 and FIG. 5, further, in some embodiments, the vibration component 70 further includes a first magnetic conductive member 78 and a second magnetic conductive member 79. The first magnetic conductive member 78 and the second magnetic conductive member 79 is disposed between the magnetic member 73 and the elastic sheet 75 and configured to stably transmit a magnetic field of the coil 72 to the magnetic member 73.

The first magnetic conductive member 78 is generally a thin flat plate in shape and is made of a magnetic conductive material. The second magnetic conductive member 79 is generally a thin flat plate in shape and is made of a magnetic conductive material. By disposing the first magnetic conductive member 78 and the second magnetic conductive member 79, the magnetic field generated by the coil 72 can be stably transmitted to the magnetic member 73, which can improve a utilization rate of magnetic field energy and guarantee timeliness and efficiency of the vibration of the vibration component 70.

As illustrated in FIG. 4 and FIG. 5, in some embodiments, the elastic sheet 75, the first magnetic conductive member 78, the second magnetic conductive member 79, the magnetic member 73, and the protective member 71 are fixedly connected by the connection member 77 sequentially passing through the elastic sheet 75, the first magnetic conductive member 78, the second magnetic conductive member 79, the magnetic member 73, and the protective member 71.

The elastic sheet 75, the first magnetic conductive member 78, the second magnetic conductive member 79, the magnetic member 73, and the protective member 71 are tightly connected. When the magnetic member 73 vibrates, it drives the elastic sheet 75, the first magnetic conductive member 78, the second magnetic conductive member 79, and the protective member 71 to vibrate together. In addition, the elastic sheet 75, the first magnetic conductive member 78, the second magnetic conductive member 79, the magnetic member 73, and the protective member 71 can be connected together without the need to provide a plurality of connection structures on the vibration component 70, resulting in a relatively simple structure of the vibration component 70.

As illustrated in FIG. 6, the headphone system 10000 according to the embodiments of the present disclosure includes the headphone 1000 according to the above-described embodiments and a charging case 3000 configured to charge the headphone 1000. The charging case 3000 has a charging compartment. When the headphone 1000 needs to be charged, the battery case of the headphone 1000 can be accommodated in the charging compartment and charge the battery inside the battery case.

In the headphone system 10000 according to the embodiments of the present disclosure, the support 50 has the through hole 53, the adhesive receiving portion 11 is disposed in the mounting cavity 51, and the through hole 53 corresponds to and is in communication with the adhesive receiving portion 11. The support 50 and the second housing 30 can be bonded and connected by the waterproof adhesive. When the support 50 and the second housing 30 are connected and jointly squeeze the waterproof adhesive, the waterproof adhesive can flow into the adhesive receiving portion 11 through the through hole 53, and the waterproof adhesive can be stored in the adhesive receiving portion 11. In this way, the problem of the waterproof adhesive between the support 50 and the second housing 30 overflowing onto the surface of the transducer assembly 100 can be avoided. Therefore, the transducer assembly 100 has better overall aesthetics, and there is no need to clean the waterproof adhesive on the surface of the transducer assembly 100, making the mounting of the transducer assembly 100 relatively simple.

In the transducer assembly, headphone, and headphone system according to the embodiments of the present disclosure, the support has the through hole, the adhesive receiving portion is disposed in the mounting cavity, and the through hole corresponds to and is in communication with the adhesive receiving portion. The support and the second housing can be bonded and connected through waterproof adhesive. When the support and the second housing are connected and jointly squeeze the waterproof adhesive, the waterproof adhesive can flow into the adhesive receiving portion through the through hole and be stored in the adhesive receiving portion. In this way, a problem of the waterproof adhesive between the support and the second housing overflowing onto the surface of the transducer assembly can be avoided. Therefore, the transducer assembly has better overall aesthetics, and there is no need to clean the waterproof adhesive on the surface of the transducer assembly, making mounting of the transducer assembly relatively simple.

Any combination of technical features in the above-described embodiments may be adopted. To make the description simple, all possible combinations of the technical features in the above-described embodiments are not described. However, as long as there is no contradiction in the combinations of the technical features in the embodiments, all such combinations should be considered in the scope of this specification. In addition, other implementations may be derived from the above-described embodiments, such that structural and logical substitutions and changes may be made without departing from the scope of the present disclosure.

The above embodiments illustrate merely some implementations of the present disclosure, which are described in details but are not construed to limit the scope of the present disclosure. It should be pointed that, for those skilled in the art, without departing from the principle of the present disclosure, various changes and improvements may be made, which are covered by the protection scope of the present disclosure. Therefore, the protection scope of the present disclosure is should be determined by the appended claims.

What is claimed is:

1. A transducer assembly, comprising:
a first housing;
a second housing, wherein the first housing and the second housing are connected to each other and jointly define an accommodation cavity; and
a support located in the accommodation cavity and connected to the second housing, wherein:
the support and the first housing jointly define a mounting cavity;
the support has a through hole; and
an adhesive receiving portion is provided in the mounting cavity, the through hole corresponding to the adhesive receiving portion.

2. The transducer assembly according to claim 1, wherein the adhesive receiving portion has an adhesive receiving space in communication with the through hole.

3. The transducer assembly according to claim 2, wherein:
the adhesive receiving portion and an inner wall of the first housing are connected to each other and jointly define the adhesive receiving space; and
the first housing has a passage hole in communication with the adhesive receiving space, the passage hole being configured to allow an electrical connector to pass through the adhesive receiving space to enter the accommodation cavity.

4. The transducer assembly according to claim 3, wherein at least a portion of the adhesive receiving portion is spaced apart from the inner wall of the first housing to form a first opening and a second opening, the adhesive receiving space being in communication with the through hole via the first opening and in communication with the passage hole via the second opening.

5. The transducer assembly according to claim 1, further comprising a vibration component located in the mounting cavity and connected to the support, the vibration component being capable of vibrating when energized.

6. The transducer assembly according to claim 5, wherein the vibration component comprises a coil, a magnetic member, and an elastic sheet, wherein:
the coil is fixedly connected to the support and surrounds the magnetic member, and the coil is further electrically connected to an electrical connector;
the elastic sheet is connected to each of the support and the magnetic member; and
a magnetic field generated by the coil when energized is coupled with a magnetic field of the magnetic member to drive the magnetic member to move; and
the magnetic member is capable of driving the elastic sheet to vibrate with a change of an energization direction of the coil.

7. The transducer assembly according to claim 6, further comprising a protective member connected to the magnetic member and surrounding the magnetic member and the coil.

8. The transducer assembly according to claim 7, wherein:
the vibration component further comprises a connection member;
the magnetic member has a first passage hole, the elastic sheet has a second passage hole, and the protective member has a third passage hole, the first passage hole, the second passage hole, and the third passage hole corresponding to one another; and
the magnetic member is connected to each of the elastic sheet and the protective member by the connection member passing through the first passage hole, the second passage hole, and the third passage hole.

9. The transducer assembly according to claim 7, wherein the vibration component further comprises a first magnetic conductive member and a second magnetic conductive member, the first magnetic conductive member and the second magnetic conductive member being disposed between the magnetic member and the elastic sheet and configured to transmit a magnetic field of the coil to the magnetic member.

10. The transducer assembly according to claim 9, wherein the elastic sheet, the first magnetic conductive member, the second magnetic conductive member, the magnetic member, and the protective member are fixedly connected by the connection member sequentially passing through the elastic sheet, the first magnetic conductive member, the second magnetic conductive member, the magnetic member, and the protective member.

11. A headphone, comprising a transducer assembly, wherein the transducer assembly comprises:
a first housing;
a second housing, wherein the first housing and the second housing are connected to each other and jointly define an accommodation cavity; and
a support located in the accommodation cavity and connected to the second housing, wherein:
the support and the first housing jointly define a mounting cavity;
the support has a through hole; and
an adhesive receiving portion is provided in the mounting cavity, the through hole corresponding to the adhesive receiving portion.

12. The headphone according to claim 11, wherein the adhesive receiving portion has an adhesive receiving space in communication with the through hole.

13. The headphone according to claim 12, wherein:
the adhesive receiving portion and an inner wall of the first housing are connected to each other and jointly define the adhesive receiving space; and
the first housing has a passage hole in communication with the adhesive receiving space, the passage hole being configured to allow an electrical connector to pass through the adhesive receiving space to enter the accommodation cavity.

14. The headphone according to claim 13, wherein at least a portion of the adhesive receiving portion is spaced apart from the inner wall of the first housing to form a first opening and a second opening, the adhesive receiving space being in communication with the through hole via the first opening and in communication with the passage hole via the second opening.

15. The headphone according to claim 11, further comprising a vibration component located in the mounting cavity and connected to the support, the vibration component being capable of vibrating when energized.

16. The headphone according to claim 15, wherein the vibration component comprises a coil, a magnetic member, and an elastic sheet, wherein:
the coil is fixedly connected to the support and surrounds the magnetic member, and the coil is further electrically connected to an electrical connector;
the elastic sheet is connected to each of the support and the magnetic member; and
a magnetic field generated by the coil when energized is coupled with a magnetic field of the magnetic member to drive the magnetic member to move; and
the magnetic member is capable of driving the elastic sheet to vibrate with a change of an energization direction of the coil.

17. The headphone according to claim 16, further comprising a protective member connected to the magnetic member and surrounding the magnetic member and the coil.

18. The headphone according to claim 17, wherein:
the vibration component further comprises a connection member;
the magnetic member has a first passage hole, the elastic sheet has a second passage hole, and the protective member has a third passage hole, the first passage hole, the second passage hole, and the third passage hole corresponding to one another; and
the magnetic member is connected to each of the elastic sheet and the protective member by the connection member passing through the first passage hole, the second passage hole, and the third passage hole.

19. The headphone according to claim 11, comprising a bone conduction headphone or an air conduction headphone.

20. A headphone system, comprising:
a headphone comprising a transducer assembly; and
a charging case configured to charge the headphone,
wherein the transducer assembly comprises:
a first housing;
a second housing, wherein the first housing and the second housing are connected to each other and jointly define an accommodation cavity; and
a support located in the accommodation cavity and connected to the second housing, wherein:
the support and the first housing jointly define a mounting cavity;
the support has a through hole; and
an adhesive receiving portion is provided in the mounting cavity, the through hole corresponding to the adhesive receiving portion.
